(19) United States
(12) Patent Application Publication
(10) Pub. No.: US 2007/0218220 A1
(43) Pub. Date: Sep. 20, 2007

(54) Methods of forming tracks and track arrangements

(75) Inventors: Paul R. Drury, Hertfordshire (GB); Stephen Temple, Cambridge (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: XAAR TECHNOLOGY LIMITED, Cambridgeshire (GB)

(21) Appl. No.: 11/503,816

(22) Filed: Aug. 14, 2006

Related U.S. Application Data
(63) Continuation of application No. PCT/GB05/00515, filed on Feb. 14, 2005.

(30) Foreign Application Priority Data
Feb. 13, 2004 (GB) 0403234.8

(51) Int. Cl. B41M 5/50

(52) U.S. Cl. 428/32.1

(57) ABSTRACT

Printed circuit board or other tracks are formed by the deposition of liquid to form dots on a substrate from nozzles mutually spaced by a distance s. A set of n dot diameters Dᵢ=2 s(1/2+i/n), is used to produce linear tracks at one or more directions with respect to an axis X; each track having a minimum track width T_{w}=s(n−2)/n; and the minimum spacing of tracks along the axis X being Tₛ=s/n.

### CROSS-REFERENCE TO RELATED APPLICATION

This is a continuation of International Application No. PCT/GB2005/000515 filed Feb. 14, 2005, the entire disclosure of which is incorporated by reference herein.

### BACKGROUND OF THE INVENTION

1. Field of the Invention

This invention relates to the formation of printed circuit board tracks (and other tracks required to have defined electrical or mechanical properties) by the deposition of liquid to form dots on a substrate.

2. Related Technology

Ink jet printing is a well-known technique for printing an image by the deposition of liquid to form dots on substrate. It has also been proposed to print circuit boards using an ink jet printing technique with conductive inks.

For printed circuit boards, there is a requirement for the accurate placement of conducting tracks at a range of widths and at a range of directions. One critical factor is the minimum separation that can be defined between adjacent tracks without risk of short-circuiting. Another critical factor is the minimum track width. With “conventional” photolithographic printed circuit board techniques, the formation of these closely spaced tracks with clearly defined straight edges, is generally not a difficulty. The conventional techniques are however expensive and time consuming, typically because of the multiple process steps that are required for each board layer. Ink jet printing offers faster and less expensive processing techniques. However, ink jet printing carries the fundamental limitation that all tracks have to be formed from circular dots at a characteristic nozzle spacing. (It is recognized that in “multi-pass” ink jet printing, dots can be formed more closely together than the characteristic nozzle spacing, by the number of passes.) Taking the simplest case of a track extending vertically (at right angles to the nozzle array), it will be clearly seen that the precision with which a desired track edge location can be addressed is restricted by the characteristic nozzle spacing s. Similarly, there are fundamental restrictions on the smoothness of the edge that can be formed and the minimum separation that can be established between adjacent tracks, without risk of short-circuit. Of course, a printed circuit board technology, should be able to form tracks at a wide range of angles or directions and not simply vertically. This presents real difficulties for ink jet printing techniques where parameters such the smoothness of a track edge will vary widely depending upon whether that edge is parallel to the grid (defined by the nozzle array and the direction of substrate scanning) or at an arbitrary angle to that grid.

Some consideration has been given in the ink jet printing of images, to enhancing the edges of typographical characters and the like. There is now a reasonable understanding of how the human eye sees “straight” edges that are in fact made up from lines of closely spaced dots. This understanding cannot, however, be transferred to printed circuit board technology since what matters with printed circuit boards is not how straight an edge might be perceived by the human eye but what is the conductivity along an intended track direction and what is the insulation between neighbouring tracks to guard against short-circuit. To give one brief example, one technique in the ink jet printing of images is to form dots that are significantly smaller than the characteristic nozzles spacing s so as to increase the straightness of a perceived edge. In the printing of images, it is of course immaterial whether the small dots physically touch or overlap. With ink jet printing of circuit boards a “perceived” increase in the straightness of a track will be useless unless the dots of ink overlap in the track which is electrically conductive and are kept as far as possible away from the dots which form adjacent, isolated tracks.

### GENERAL DESCRIPTION OF THE INVENTION

The invention provides improved methods and arrangements for forming tracks having defined electrical or mechanical properties, by the deposition of liquid to form dots on a substrate which enable tracks to be formed at a given nozzle spacing with increased precision of track placement.

Accordingly the invention provides a method of forming an arrangement of tracks having defined electrical or mechanical properties, by the deposition of liquid to form dots on a substrate from nozzles mutually spaced by a distance s; the method comprising the steps of defining a set of n dot diameters Dᵢ=2s(1/2+i/n), where i is a running integer from 0 to (n−1); depositing liquid to form linear tracks at one or more directions with respect to an axis X; each track having a minimum track width T_{w}=s(3n−2)/n; and the minimum spacing of tracks along the axis X being Tₛ=s/n. In a preferred example, the dot diameters: s, 1.5s, 2s and 2.5s are employed.

By choosing dot diameters Dᵢ=2s(1/2+i/n), it is arranged that a track edge can be located to within s/n of any desired location.

In another aspect, the invention provides an arrangement of tracks having defined electrical or mechanical properties formed by the deposition of liquid to form dots on a substrate at a regular array of deposition locations mutually spaced by a distance s, the dots having a set of n dot diameters Dᵢ=2s(1/2+i/n), where i is a running integer from 0 to (n−1); the arrangement comprising linear tracks oriented at orientations with respect to an axis X, at least one track having a track width T_{w}=s(3n−2)/n; and at least two tracks having a mutual spacing Tₛ along the axis X of Tₛ=s/n. In a preferred example, the dot diameters: s, 1.5s, 2s and 2.5s are employed.

In still another aspect, the invention provides a method of forming a linear track having defined electrical or mechanical properties by the deposition of liquid to form dots on a substrate from nozzles mutually spaced by a distance s, the track being inclined to an axis X; the method comprising the steps of defining a set of at least three dot diameters Dᵢ where the smallest dot diameter Dₘᵢₙ≧s and the largest diameter Dₘₐₓ≦3s ; and repeatedly forming a dot pattern comprising at least three dots in a line parallel to the axis X, the first and third of these dots being of diameters which are equal and which are less than the diameter of the second dot, each succeeding repetition of the dot pattern being offset from the preceding pattern a distance s in the direction orthogonal to the direction X and a distance equal to or greater than s in the direction X.

Preferably, the set comprises n dot diameters Dᵢ=2s(1/2+i/n), where i is a running integer from 0 to (n−1).

Advantageously, the dot pattern takes the form at one angle of:

D₀, D₁, D₂, . . . Dᵢ, . . . Dₙ₋₁, . . . Dᵢ, . . . D₂, D₁,D₀

with dots in the pattern being progressively removed for increasing angles and dots in the pattern being progressively repeated for decreasing angles.

In still another aspect, the invention provides a linear track having defined electrical or mechanical properties formed by the deposition of liquid to form dots on a substrate at a regular array of deposition locations mutually spaced by a distance s, the track being inclined to an axis X; the track comprising a repeated dot pattern comprising at least three dots in a line parallel to the axis X, the first and third of these dots being of diameters which are equal and which are less than the diameter of the second dot, each succeeding repetition of the dot pattern being offset from the preceding pattern a distance s in the direction orthogonal to the direction X and a distance equal to or greater than s in the direction X.

Preferably, the set comprises n dot diameters Dᵢ=2s(1/2+i/n), where i is a running integer from 0 to (n−1).

Advantageously, the dot pattern takes the form at one angle of:

D₀, D₁, D₂, . . . Dᵢ, . . . Dₙ₋₁, . . . Dᵢ, . . . D₂, D₁,D₀

with dots in the pattern being progressively removed for increasing angles and dots in the pattern being progressively repeated for decreasing angles.

In yet another aspect, the invention provides a substrate having formed thereon at least one track having defined electrical or mechanical properties formed by the deposition of liquid to form dots on a substrate at a regular array of deposition locations mutually spaced by a distance s, the track having an edge being inclined to an axis X; the track edge comprising a repeated dot pattern comprising at least three dots in a line parallel to the axis X, the diameters of the dots increasing along the line, each succeeding repetition of the dot pattern being offset from the preceding pattern a distance s in the direction orthogonal to the direction X and a distance equal to or greater than s in the direction X.

In still another aspect, the invention provides a method of defining a gap between two planar structures having defined electrical or mechanical properties by the deposition of liquid to form dots on a substrate at a regular array of deposition locations mutually spaced by a distance s, parallel to an axis X; the method comprising the steps of defining a set of n dot diameters Dᵢ=2s(1/2+i/n), where i is a running integer from 0 to (n−1); forming pairs of dots at respective sides of the gap at locations spaced by 2s; the sum of the diameters of the pair of dots equalling 2s(2n−1)/n.

In still another aspect, the invention provides a method of forming a track, said method comprising the steps: assigning a grid of addressable pixels to a substrate, said grid having a predetermined spacing s, where s is a distance; selecting for each pixel a dot of one of n predetermined sizes, wherein n is an integer greater than 2; forming the dots on the substrate and thereby forming the track; wherein at least one of the predetermined sizes of dots has a diameter greater than s√2.

Preferably, the diameter is not less than 2s, and the predetermined size of a dot for each pixel is selected such that a straight-line track edge is approximated by said dots to within s/n.

In still another aspect, the invention provides a method of approximating a straight track edge on a substrate, said track edge being approximated by a plurality of dots, each dot having one of n diameters, where n is greater than 2;said method comprising the steps: assigning a grid of addressable pixels to a substrate, said grid having a predetermined spacing s; calculating the position of said profile with respect to said addressable pixels; determining for each addressable pixel whether a portion of profile adjacent or within a pixel would be better approximated by a dot in said pixel or by a dot in a neighboring pixel; and displaying a dot in said determined pixel.

Preferably, at least one of the n diameters of dots is greater than s√2 and more preferably not less than 2s.

Advantageously, at least one dot is displayed in a neighboring pixel which is not an adjacent pixel.

In still another aspect, the invention provides a track arrangement on a substrate, said arrangement comprising two groups of dots, said dots being arranged in a plurality of addressable pixels, the addressable pixels-have an inter dot spacing, measured from the centre of a pixel to the centre of an adjacent pixel of s; wherein the dots of each group overlap and each dot has one of n diameters, wherein n is an integer greater than 2 ; wherein each group has an edge approximated by said dots; wherein the distance between the two edges is of the order s/n.

### BRIEF DESCRIPTION OF THE DRAWINGS

The invention will now be described, by way of example only, with reference to the following drawings in which:

FIG. 1 depicts an angled track printed with a conventional binary printhead.

FIG. 2 depicts a track printed in a conventional greyscale method.

FIG. 3 depicts a track printed according to the invention.

FIG. 4 depicts another track printed according to the invention.

FIG. 5 depicts tracks at four different angles with a first drop set.

FIG. 6 depicts tracks at three different angles with a second drop set.

FIG. 7 depicts a further track printed according to the invention.

FIG. 8a-d depicts a corner printed according in a binary scheme.

FIGS. 9 to 11 depict addressable edges achievable according to a printing scheme according to the invention.

FIG. 12a to 12c shows how an error may be minimized.

FIG. 13 depict the range of dots that may be produced with 16 grey levels

FIG. 14 depicts a two-pixel width track according to the invention.

FIG. 15 is an image of a track printed in a binary scheme.

FIG. 16 and FIG. 17 are images of tracks printed according to the invention.

FIG. 18 depicts the formation of an gap of minimum width and arbitrary form, according to this invention.

### DETAILED DESCRIPTION OF THE INVENTION

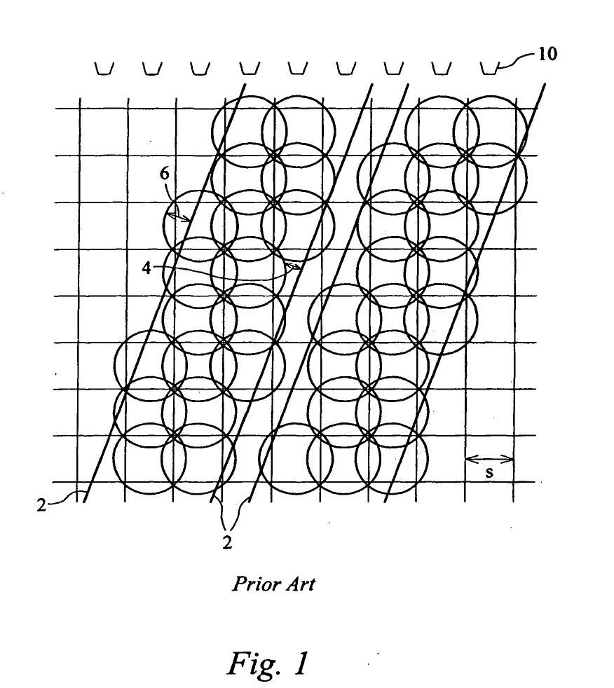

Referring initially to FIG. 1, there is shown a conventional ink jet printing technique for forming tracks using “binary” printing, that is to say with a single dot diameter. Droplets of liquid are deposited from nozzles 10 using any appropriate ink jet printing technology. These nozzles 10 are spaced at a distance s and the dots formed by the ejected ink droplets lie on a rectangular grid having a spacing s in the direction along the nozzle array and a dimension in the orthogonal direction which is determined by the rate of scanning of the substrate past the nozzle array and the frequency of droplet ejection. This dimension may typically also be s. It will be understood that dots can be formed at a spacing which is less than the nozzle spacing s in the direction of the nozzle array with multiple passes of the nozzle array over the substrate.

In this arrangement, each dot is of a uniform size equal to s√2. Each dot overlaps the edge of adjacent pixel by distance which is equal to (s√2−s). The intended edges of the tracks in FIG. 1 are shown by lines 2. It will be seen that at some points (for example those marked at 4 and 6) approximation to the line 2 is poor. However, no greater accuracy is possible in a single pass operation at a given value s. Looked at another way, the width of the track varies considerably with the track being at some point two dots wide and at other points three points wide. For the very narrow tracks increasingly required in the fabrication of electronic circuitry, this variation in track width leads to an unacceptable increase in resistance and high frequency emissions. It will also be apparent that the minimum inter-track spacing is equal to (s−2(s√2−s)). At most points along the tracks, however, the inter-track spacing is significantly greater. This will not generally give the required efficiency in circuit board utilisation.

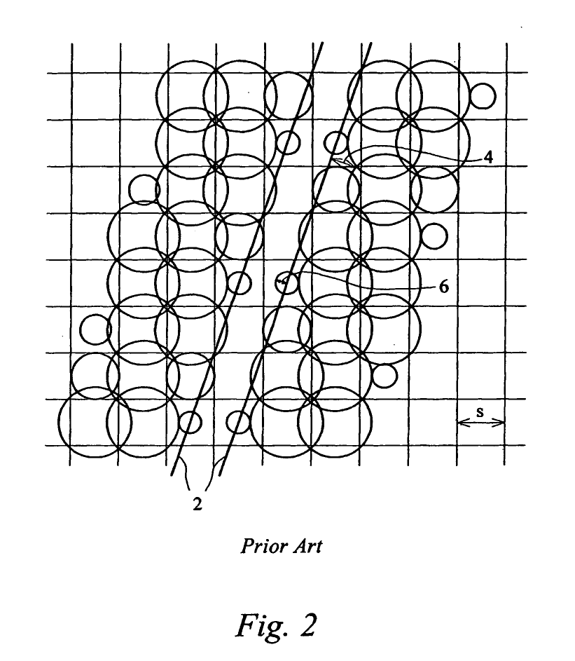

FIG. 2 illustrates a prior art attempt to print the same tracks, now with a number of different dot diameters in “grey scale” printing. In a typical arrangement the largest dot diameter corresponds to the dot diameter s√2 of the binary system illustrated in FIG. 1, but a number of smaller dot diameters are provided, in this case two such smaller dot diameters. With a printed image, the grey scale approach would be expected to produce a significantly straighter perceived edge. In the present situation, however, it will be seen that the smallest dot size when placed along the edge of the track to improve the perceived straightness, actually has very little effect upon the conductivity of the track since each of these smallest dot sizes typically abuts only one of the neighboring dots.

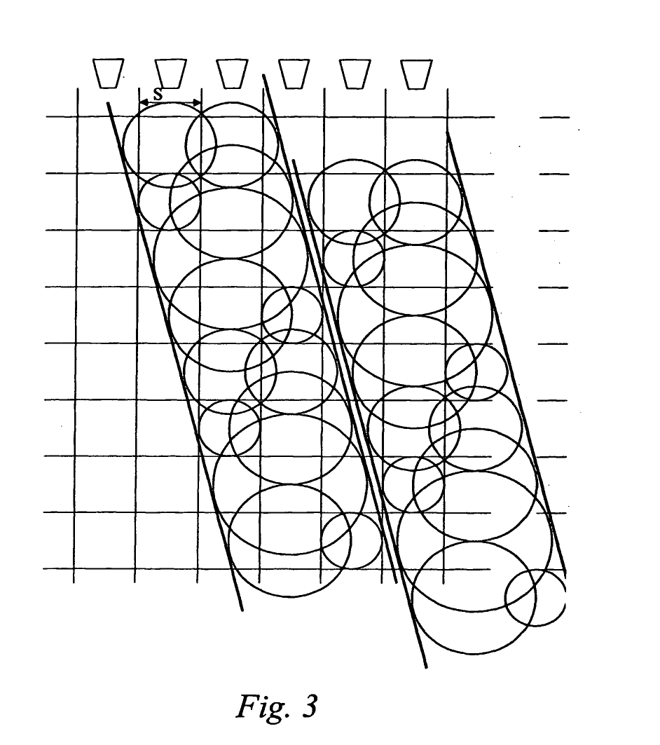

An arrangement according to the invention will now be described with reference to FIG. 3. As with the previous figures, nozzles 10 are illustrated schematically at a nozzle spacing s, this spacing defining a grid 32 with reference to the substrate. This grid is depicted as square although it will be understood that the dimension in the direction orthogonal to the nozzle array (that is to say the vertical dimension in the drawing) need not necessarily be equal to s. In the arrangement of FIG. 3, four dot diameters D are employed. Each dot is centred on a grid square, the smallest dot diameter D being set equal to s. The next size dot diameter is chosen so that the circumference of the dot overlaps the adjacent grid squares by up to one quarter of the width of that grid square. That is to say, the next dot diameter is chosen so that D₂=1.5s. Similarly, the remaining dots are chosen so as to overlap by 50% and 75% respectively the adjacent grid squares, taking values D₃=2s and D₄=2.5s. Generalising to a value n of dot diameters, it will be seen that these dot diameters DI are given by:
Dᵢ=2s(1/2+i/n), where i is a running integer from 0 to (n−1)

The dot patterns which are used to form the narrow, closely spaced tracks are highly ordered. It will be seen that the pattern of dots produced by the droplets from a single nozzle (that is to say a vertical column in the representation of FIG. 3) form an ascending sequence D₁, D₂, D₃, D₄ and a descending sequence D₄, D₃, D₂, D₁. This ascending and descending sequence from the smallest dot diameter to the largest dot diameter and back to the smallest dot diameter has particular preferred characteristics in the ability to form narrow closely spaced tracks over a range of angles (with respect to the grid axis).

This explanation concentrates on the minimum track width for the reason that it is straightforward to produce tracks of larger width. Such larger track widths can be formed by repeating the characteristic dot patterns shown in FIG. 3. In certain cases, and typically with larger track areas, it will be appropriate to use the characteristic dot patterns shown in FIG. 3 at the edges of the wide track with possibly other dot patterns in the centre of the track region. Those other dot patterns may be chosen to optimize efficiency of area coverage. The minimum track width achievable with the arrangement of FIG. 3 at an arbitrary angle is:
T_{w}=s(3n−2)/n

At an arbitrary angle, the preferred arrangement guarantees a minimum spacing of tracks parallel to the grid axis of s/n (with s being replaced by the other grid dimension if a non-squared grid is employed).

The grid depicted in the figures is at a spacing of 360 dpi i.e. the centre of each dot is approximately 70 μm apart in each axis. This equates to distance s. The shown grid could, however, be 720, 1440 or 2880 dpi or some other resolution. The dots are deposited by an inkjet print head into the centre of each of the addressable pixels.

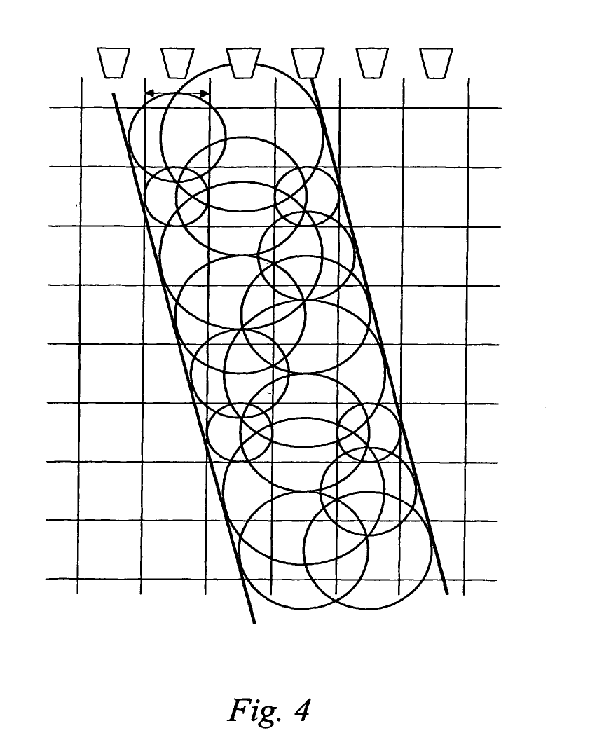

The arrangement depicted in FIG. 4 produces an increased track width. It will be seen that in this case, the ascending and descending sequences of dot diameters D₁, D₂, D₃, D₄, still define the track edge, but instead of inserting an increased diameter D₅ in the sequence, the “central” diameter in the sequence is D₄ with the increased track width arising from the appearance in the same row of the grid of a dot diameter D₁ from the “end” of a sequence in the left-hand neighboring column and a dot diameter D₁ at the “beginning” of a sequence in the right-hand grid column. This approach can be extended by replacing the dot at the centre of the ascending and descending sequence by a dot of diameter D₂, this dot then cooperating with equal size dots in the left-hand and right-hand neighboring grid columns to form an incrementally wider track.

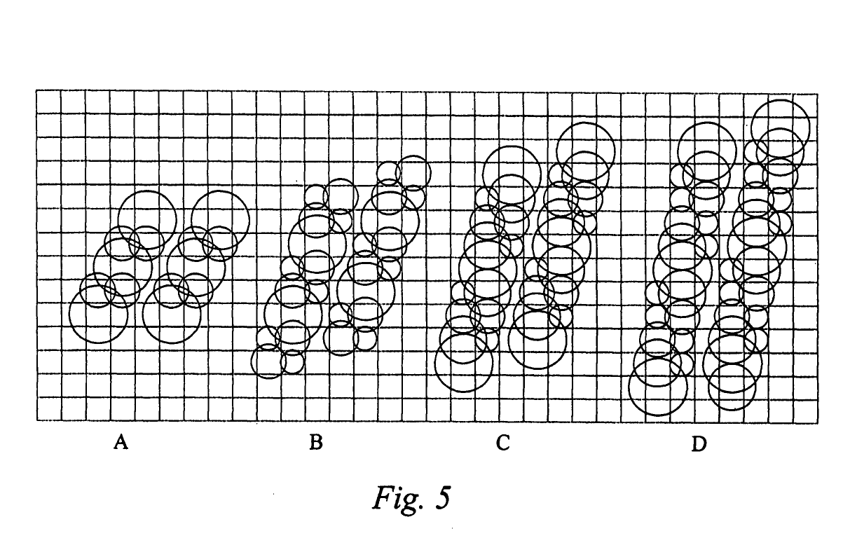

FIG. 5 illustrates tracks formed at four different angles. In each case n=4 and the drop diameters are:

D₀=1.0 s

D₁=1.5s

D₂=2.0s

D₃=2.5s

FIG. 5 shows (at A) parallel tracks having a width 2.5s at an angle arctan 2. It will be seen that the tracks are formed from the repeating drop pattern D₁, D₃, D₁ with each repeat of the pattern being offset a distance s horizontally (in the drawing) and a distance 2s (thus giving arctan 2) vertically.

At (B), an arrangement is shown with the repeating pattern

D₀, D₁, D₃, D₁, D₀ offset a distance s horizontally (in the drawing) and a distance 3s vertically, providing a track angle of arctan 3. It is important to note that this different angle is achieved without a change in track width.

At (C), an arrangement is shown with the repeating pattern

D₀, D₁, D₂, D₃, D₂, D₁, D₀ offset a distance s horizontally (in the drawing) and a distance 4s vertically, providing a track angle of arctan 4. Again, that this different angle is achieved without a change in track width.

The diagrams (A), (B) and (C) illustrate examples of the pattern:

D₀, D₁, D₂, . . . Dᵢ, . . . Dₙ₋₁, . . . Dᵢ, . . . D₂, D₁,D₀

with dots in the pattern being progressively removed for increasing angles from (C) to (A). To decrease the angle from that of (C), dots in the pattern can be

repeated. Thus FIG. 5 shows at (D) the repeating pattern D₀, D₀, D₁, D₂, D₃, D₂, D₁, D₀, D₀ to provide an angle of arctan 5.

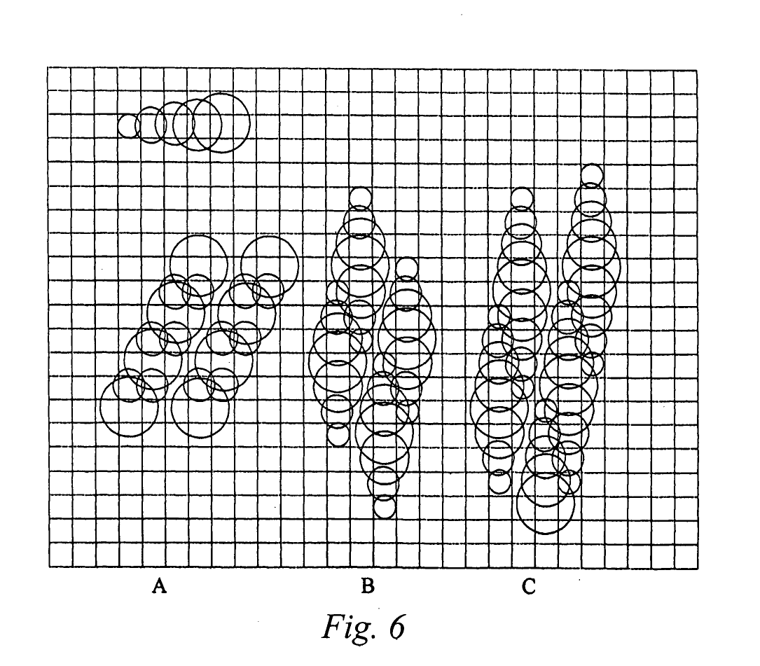

FIG. 6 shows at (A), (B) and (C) tracks of minimum width 2.6s with five dot sizes:

D₀=s

D₁=1.4s

D₂=1.8s

D₃=2.2s

D₄=2.6s

At (A), tracks are shown formed from the repeating drop pattern D₁, D₄, D₁ with each repeat of the pattern being offset a distance s horizontally 2s vertically.

At (B), an arrangement is shown with the repeating pattern

D₀, D₁, D₃, D₄, D₃, D₁, D₀ offset a distance 4s vertically, providing a track angle of arctan 4.

At (C), an arrangement is shown with the repeating pattern

D₀, D₁, D₂, D₃, D₄, D₃, D₂, D₁, D₀ offset a distance 5s vertically, providing a track angle of arctan 5. Again, note that these different angles are achieved without a change in track width. Similarly, angles can be increased or decreased by omitting or repeating drops in the repeating pattern.

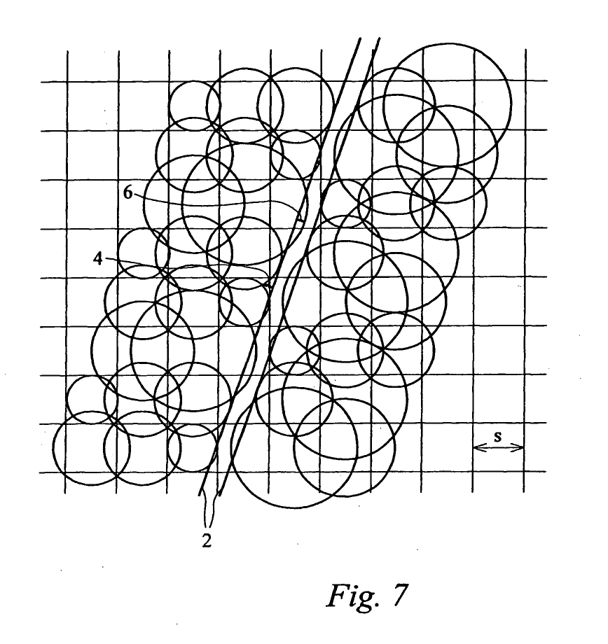

A further embodiment of the invention is illustrated at FIG. 7. The tracks may be formed in a single pass of the print head as a single dot is displayed in each addressable pixel. One of a number of predetermined dot sizes may be displayed in a respective pixel. In contrast to the conventional greyscale at least one, and preferably two or more of the predetermined dots have a diameter that is greater than s√2. The dots shown have diameters on the substrate that increase by a substantially regular amount i.e. s, 1.5s, 2s and 2.5s.

Using the above dot sizes enables the addressability of an edge to within s/n and therefore the approximation of a desired track edge location to within s/n. As can be seen from FIG. 7, this ability to address an edge enables the tracks to be spaced with a smaller inter-track spacing than with a binary or conventional greyscale display that is equal, in the smallest case, to s/n.

Where a track is provided that has two parallel edges it is preferred in this embodiment that the edges are spaced at least 3s apart. This ensures that both edges can be approximated by respective dots to similar degrees of accuracy.

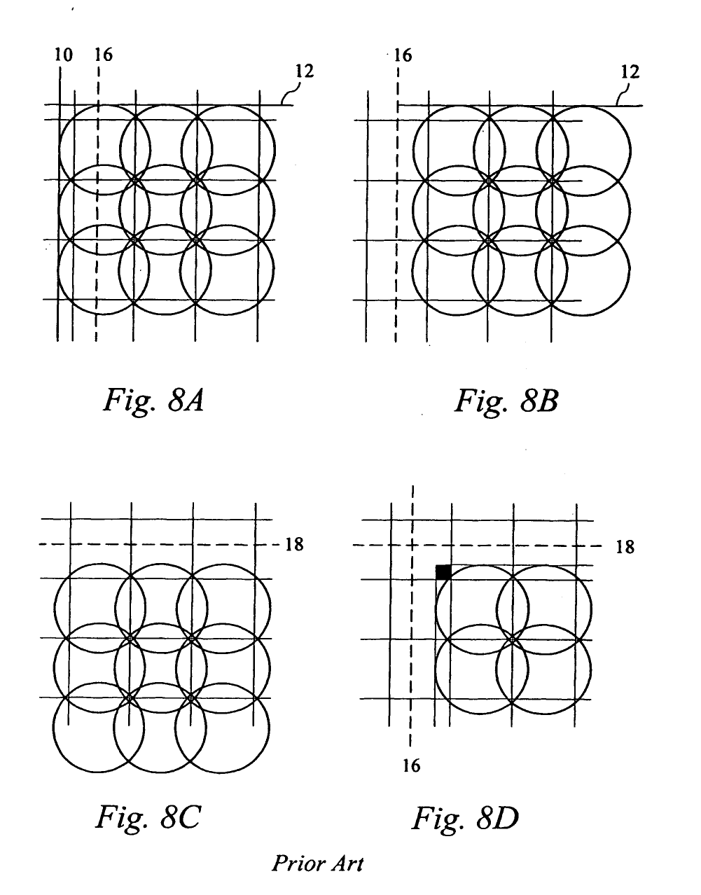

The addressability of a row of dots to an edge will be described in greater detail with respect to FIG. 8 to FIG. 11. These figures show a corner printed first in binary, FIG. 8, and secondly with the multiple dot sizes according to the invention. All the figures are displayed at the same pixel grid addressability.

For the binary (prior art) print of FIG. 8a to d, where a single dot size is displayed, it is clear that an edge 10, 12 may be addressed to a single point in the pixel. Thus, for example, if an edge is required to be addressed at a point equal to x % across a pixel, as shown by hatchedline 16, the error is equal to −((x/100.s)−(s−s√2)) or +(s√2−(x/100.s)). Clearly, at certain values of X, for example 80% the error is quite large either −0.38s or +0.61s. This places significant constraints on image quality and the location of the edge.

For a conventional greyscale image, where a plurality of dots smaller than the size of the grid spacing s is used, and the dots are displayed at the centre of the each of the addressable pixels, the maximum error is given by the equation: ±1/2((1/2s+rsd/100.s)−(rld/100.s−s))

where rsd is the radius of the smallest drop and rld is the radius of the largest drop as percentages of s.

For the situation where the radius of the largest drop is 1.4s i.e. rld=140% of s and the radius of the smallest drop is 0.2s i.e. 20% of s, the maximum error displayed is equal to ±0.15s i.e. 15% of s. This maximum error would be the same regardless of the number of grey levels used between the largest and smallest drops.

It will be apparent that there is a natural limitation to the minimum drop volume that may be ejected since as the volume decreases the relative air drag increases to a point that an unachievable velocity is required from the print head to ensure the droplet reaches the substrate. The current limit on the smallest drop volume would be around 2 pl, which would provide a dot size of the order 23 μm on the substrate. This, for a 70 μm grid spacing, equates to just over 30% of the grid.

It is important to remember that for a displayed image, where there is no requirement for dots to touch, it may be acceptable to use the smaller dot sizes. Where the dots conduct electricity it will be apparent that the smallest dot in the above example will only touch a neighboring dot in one axis leading to a higher resistance in the image, as described with reference to FIG. 2.

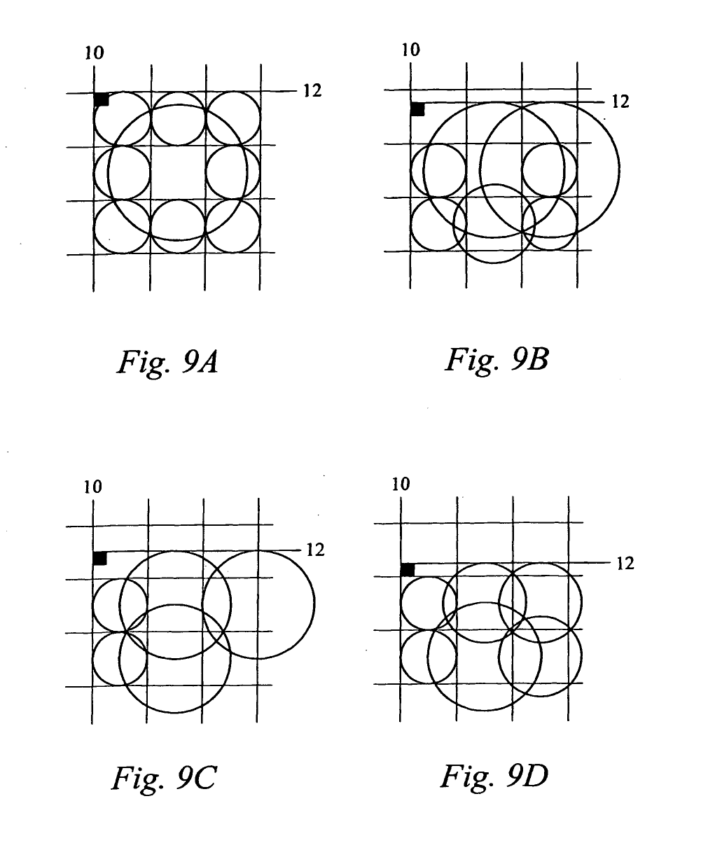

An aspect of the invention will now be further described with reference to FIGS. 9 to 11. FIG. 9a to d depicts an track edge having a line 10 approximated by dots and a second line 12 similarly approximated by dots. The first profile 10 is fixed with respect to the pixel grid and the second profile 12 is varied in accordance with a desired edge addressability. As can be seen, where each dot has a regular increase in size over a smaller dot and where the smallest dot has a diameter equal to s, and the largest diameter is equal to 2.6s then the profile 12 may be addressed to within s/n, where n in this case is 3. The maximum error is therefore 1/2s/n.

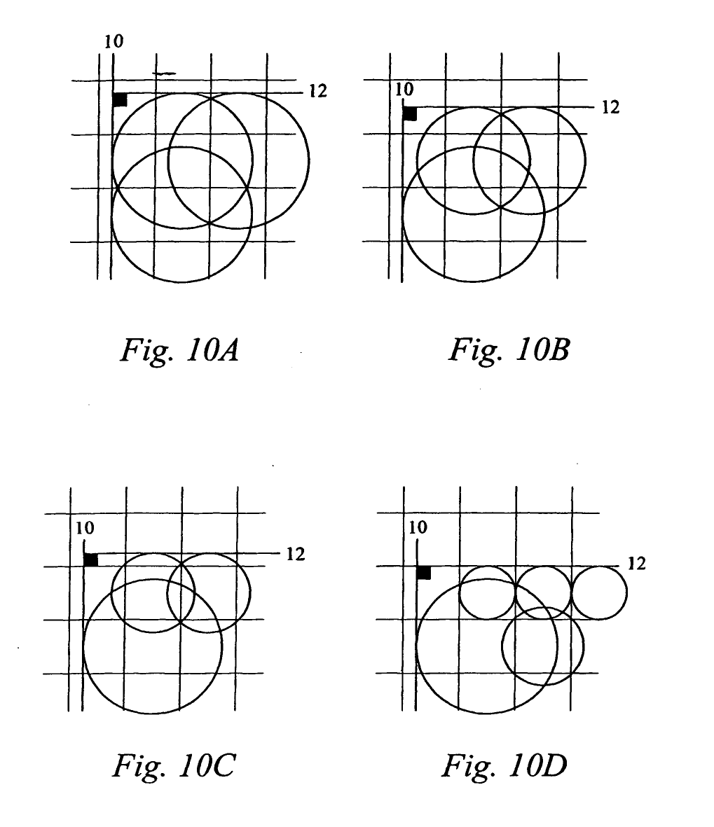

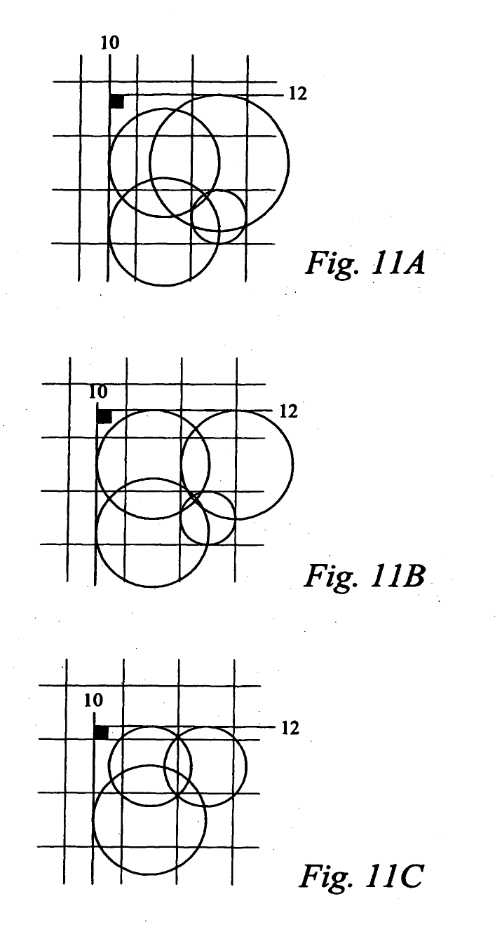

The addressability of profile 10 may similarly be defined to within a distance of s/n as depicted self evident manner in FIGS. 10 and 11.

By adding in further predetermined dot sizes at a regular increase in size it is possible to further improve the edge addressability. There is fundamentally no inherent limitation to the edge addressability that may be achieved.

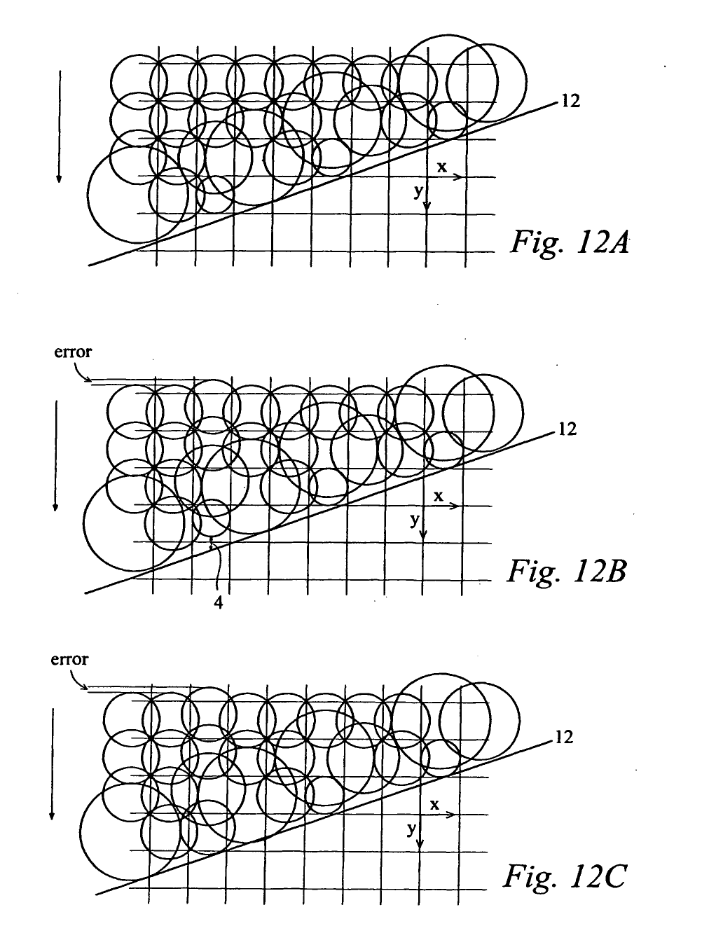

A further advantage of the invention lies in the ability to compensate for drop landing or other dot positioning errors. FIG. 12a depicts track having an inclined track edge 2. Each dot is perfectly centred on the grid and can accurately approximate the smoothed profile 2 using 3 different drop sizes. In FIG. 12b, one of the dots formed by the print head has an error in the Y or scanning direction. If the same algorithm is used to produce the image as used to form the image of FIG. 12b, then the line 2 does not produce the best fit.

In single pass printing, where each column is produced by a single dot generating element it is possible to modify the algorithm such that the dot size produced by the dot generating element is modified either to increase or reduce the size of the dot such that the profile is better approximated, as depicted in FIG. 12c.

The change may be permanent in that it is applied to every future image or may be varied on an image by image basis.

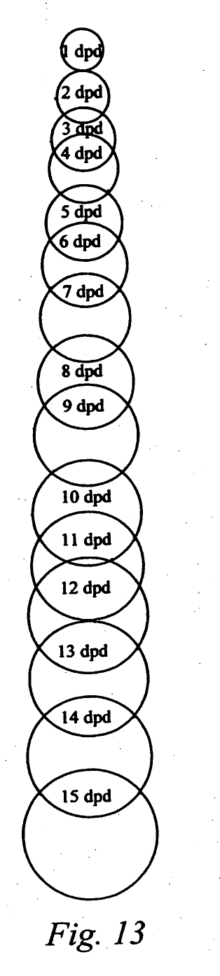

It is also think of arrangements according to the invention serving to shift the “centre of gravity” of a track by modifying the weighting of dots used to form the track. Using a print head, commercially available from Xaar under the trade name “LEOPARD” it is possible to print fifteen different sizes of drop as depicted in FIG. 13, the typical diameters of the dots are given in the table below.

| Number of sub-droplets | Typical diameter |
|---|---|
| per dot (dpd) | (μm) |
| 1 | 39 |
| 2 | 55 |
| 3 | 68 |
| 4 | 78 |
| 5 | 87 |
| 6 | 96 |
| 7 | 103 |
| 8 | 110 |
| 9 | 117 |
| 10 | 124 |
| 11 | 130 |
| 12 | 135 |
| 13 | 141 |
| 14 | 146 |
| 15 | 151 |

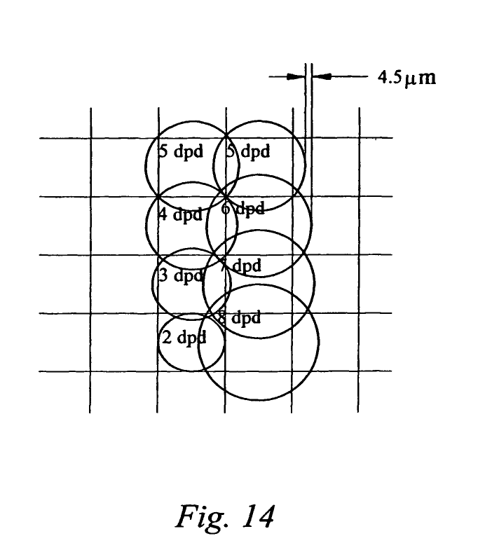

In FIG. 14, the dot sizes can be used to generate very slight angles to a track. These angles can by modified in succession, thereby producing accurate and smooth curves, which can minimize efficiency of the track and minimize HF emissions.

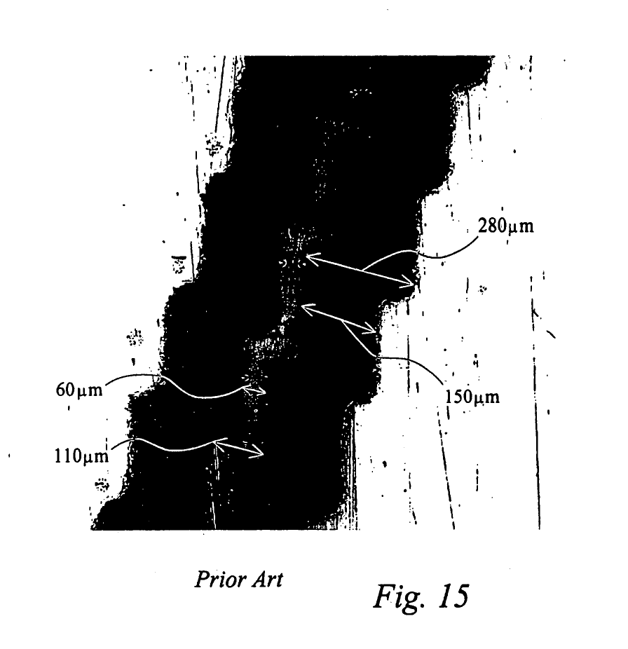

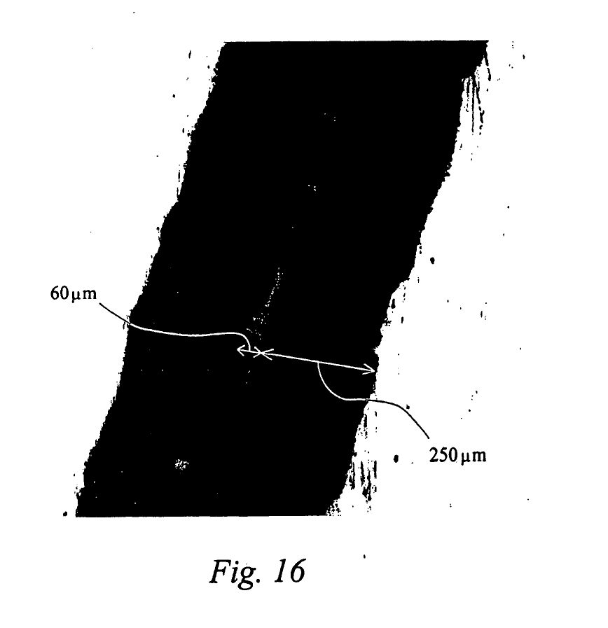

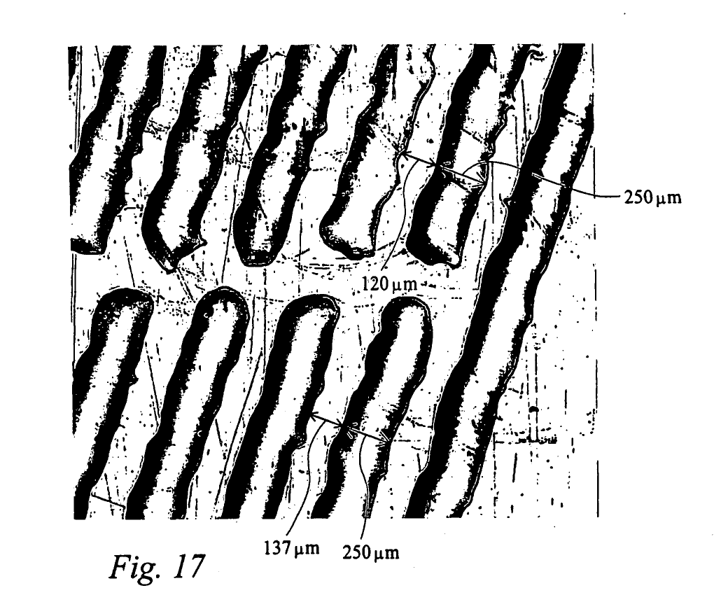

FIGS. 15 to 17 depict actual images printed by an inkjet print head depositing 4 dot sizes on the substrate. FIG. 15 is printed in binary and the tracks have a width ranging between 150 microns and 280 microns. By contrast, FIG. 16 is a corresponding track printed via a routine according to the invention. The track has a more uniform width that that of the track printed in binary. FIG. 17 depicts a plurality of tracks printed side by side. The upper tracks have a pitch of 371 μm, while the lower tracks have an inter track spacing of 389 μm.

In another aspect of this invention, attention can be focused not upon the tracks themselves but on the gaps between them. In certain applications there will be the need to establish a minimum gap between two tracks, where the track edges are not straight lines. According to this invention, with a set of n dot diameters Dᵢ=2s(1/2+i/n), where i is a running integer from 0 to (n−1); pairs of dots are formed at respective sides of the gap at locations spaced by 2s. It is then ensured that the sum of the diameters of the pair of dots equals 2s(2n−1)/n.

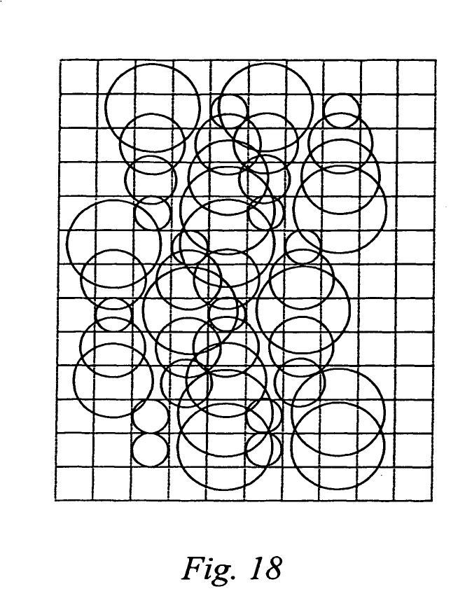

This is illustrated in FIG. 18, where a track arrangement is formed from a set of five dots having dot diameters:

D₀=s

D₁=1.4s

D₂=1.8s

D₃=2.2s

D₄=2.6s

It will be that at either side of each gap, pairs of dots are formed, with centres spaced by 2s. Only the pairs D₀/D₄, D₁/D₃ and D₂/D₂ are employed.

These pairs are characterized in that their diameters sum to s+D₄. This can be more generally expressed as 2s(2n−1)/n.

FIG. 14 also illustrates the feature that by forming two gaps of the same form closely together, a track can be produced of narrow width and arbitrary form.

It will be understood that this invention has been described by way of examples only and that a wide variety of developments and modifications are possible without departing from the scope of the invention.

Thus for larger track areas, it may be preferable to use the above-described techniques to define the track edges, with alternative dot structures used to fill in the bulk of the track. Multi-layer printed circuit boards can be formed, with the above-described techniques also used to create interconnecting vias or insulating patterns.

In a further example, conductive tracks can be formed not only by the direct printing techniques that have been described in detail, but also by indirect techniques. Thus the above described techniques can be employed to form an etch mask, used subsequently to form conductive tracks.

While the invention has been described above with respect to dots printed on a substrate and especially dots printed on a substrate in a single pass of an inkjet print head, other methods of generating the dots are envisaged. The term “track” is not intended to be limited to an electrically conducting track. Other applications in which the invention may also be of benefit are those in which a surface texture or profile is required from a single pass of a print head. Such textures or profiles may be required for artistic purposes or functional purposes e.g. creating bumps for solder, wells for containing other material, pressure pads, separators, or lenses. The invention may also be used in the generation of optical displays or images projected onto a surface. For optical displays, the displays may be static or they may display variable image data. OLEDs or LEDs may display the image.

By forming the same or different arrangements of tracks in repeated layers, three dimensional structures may be constructed.

1. A method of forming an arrangement of tracks having defined electrical or mechanical properties, by the deposition of liquid to form dots on a substrate from nozzles mutually spaced by a distance s; the method comprising the steps of defining a set of n dot diameters Dᵢ=2s(1/2+i/n), where i is a running integer from 0 to (n−1); depositing liquid to form linear tracks at one or more directions with respect to an axis X; each track having a minimum track width T_{w}=s(3n−2)/n; and the minimum spacing of tracks along the axis X being Tₛ=s/n.

2. A method according to claim 1, comprising employing the dot diameters: s, 1.5s, 2s and 2.5s.

3. An arrangement of tracks having defined electrical or mechanical properties formed by the deposition of liquid to form dots on a substrate at a regular array of deposition locations mutually spaced by a distance s, the dots having a set of n dot diameters Dᵢ=2s(1/2+i/n), where i is a running integer from 0 to (n−1); the arrangement comprising linear tracks orientated at orientations with respect to an axis X, at least one track having a track width T_{w}=s(3n−2)/n; and at least two tracks having a mutual spacing Tₛ along the axis X of Tₛ=s/n.

4. An arrangement according to claim 3, wherein the dot diameters: s, 1.5s, 2s and 2.5s are employed.

5. A method of forming a linear track having defined electrical or mechanical properties by the deposition of liquid to form dots on a substrate from nozzles mutually spaced by a distance s, the track being inclined to an axis X; the method comprising the steps of defining a set of at least three dot diameters Dᵢ where the smallest dot diameter Dₘᵢₙ≧s and the largest diameter Dₘₐₓ≦3s; and repeatedly forming a dot pattern comprising at least three dots in a line parallel to the axis X, the first and third of these dots being of diameters which are equal and which are less than the diameter of the second dot, each succeeding repetition of the dot pattern being offset from the preceding pattern a distance s in the direction orthogonal to the direction X and a distance equal to or greater than s in the direction X.

6. A method according to claim 5, wherein the set comprises n dot diameters Dᵢ=2s(1/2+i/n), where i is a running integer from 0 to (n−1).

7. A method according to claim 6, wherein the dot pattern takes the form at one angle of:
D₀, D₁, D₂, . . . Dᵢ, . . . Dₙ₋₁, . . . Dᵢ, . . . D₂, D₁,D₀
with dots in the pattern being progressively removed for increasing angles and dots in the pattern being progressively repeated for decreasing angles.

8. A linear track having defined electrical or mechanical properties formed by the deposition of liquid to form dots on a substrate at a regular array of deposition locations mutually spaced by a distance s, the track being inclined to an axis X; the track comprising a repeated dot pattern comprising at least three dots in a line parallel to the axis X, the first and third of these dots being of diameters which are equal and which are less than the diameter of the second dot, each succeeding repetition of the dot pattern being offset from the preceding pattern a distance s in the direction orthogonal to the direction X and a distance equal to or greater than s in the direction X.

9. A track according to claim 8, wherein the set comprises n dot diameters Dᵢ=2s(1/2+i/n), where i is a running integer from 0 to (n−1).

10. A track according to claim 9, wherein the dot pattern takes the form at one angle of:
D₀, D₁, D₂, . . . Dᵢ, . . . Dₙ₋₁, . . . Dᵢ, . . . D₂, D₁,D₀
with dots in the pattern being progressively removed for increasing angles and dots in the pattern being progressively repeated for decreasing angles.

11. A substrate having formed thereon at least one track having defined electrical or mechanical properties formed by the deposition of liquid to form dots on a substrate at a regular array of deposition locations mutually spaced by a distance s, the track having an edge being inclined to an axis X; the track edge comprising a repeated dot pattern comprising at least three dots in a line parallel to the axis X, the diameters of the dots increasing along the line, each succeeding repetition of the dot pattern being offset from the preceding pattern a distance s in the direction orthogonal to the direction X and a distance equal to or greater than s in the direction X.

12. A method of defining a gap between two planar structures having defined electrical or mechanical properties by the deposition of liquid to form dots on a substrate at a regular array of deposition locations mutually spaced by a distance s, parallel to an axis X; the method comprising the steps of
defining a set of n dot diameters Dᵢ=2s(1/2+i/n), where i is a running integer from 0 to (n−1); forming pairs of dots at respective sides of the gap at locations spaced by 2s; the sum of the diameters of the pair of dots equalling 2s(2n−1)/n.

13. A method of forming a track, said method comprising the steps: assigning a grid of addressable pixels to a substrate, said grid having a predetermined spacing s, where s is a distance; selecting for each pixel a dot of one of n predetermined sizes, wherein n is an integer greater than 2; forming the dots on the substrate and thereby forming the track; wherein at least one of the predetermined sizes of dots has a diameter greater than s√2.

14. A method according to claim 13, wherein the diameter is not less than 2s.

15. A method according to claim 13, comprising selecting the predetermined size of a dot for each pixel such that a straight-line track edge is approximated by said dots to within s/n.

16. A method according to claim 13, wherein the edge lies at an angle to the axis of the addressable grid.

17. A method according to claim 13, comprising forming a structure from a plurality of layers wherein each layer has a respective edge corresponding to the track edge.

18. A method of approximating a straight track edge on a substrate, said track edge being approximated by a plurality of dots, each dot having one of n diameters, where n is greater than 2;said method comprising the steps: assigning a grid of addressable pixels to a substrate, said grid having a predetermined spacing s; calculating the position of said profile with respect to said addressable pixels; determining for each addressable pixel whether a portion of profile adjacent or within a pixel would be better approximated by a dot in said pixel or by a dot in a neighboring pixel; and displaying a dot in said determined pixel.

19. Method according to claim 18, wherein at least one of the n diameters of dots is greater than s√2.

20. Method according to claim 18, wherein at least one of the n diameters of dots is not less than 2s.

21. Method according to claim 18, comprising displaying at least one dot in a neighboring pixel which is not an adjacent pixel.

22. Method according to claim 18, wherein the dots approximate the track edge to within s/n.

23. A track arrangement on a substrate, said arrangement comprising two groups of dots, said dots being arranged in a plurality of addressable pixels, the addressable pixels have an inter dot spacing, measured from the centre of a pixel to the centre of an adjacent pixel of s; wherein the dots of each group overlap and each dot has one of n diameters, wherein n is an integer greater than 2; wherein each group has an edge approximated by said dots; wherein the distance between the two edges is of the order s/n.
